(19) United States
(12) Patent Application Publication
(10) Pub. No.: US 2005/0287998 A1
(43) Pub. Date: Dec. 29, 2005

(54) Conference assisting system and method

(75) Inventor: Toshio Tonouchi, Tokyo (JP)

Correspondence Address: MCGINN INTELLECTUAL PROPERTY LAW GROUP, PLLC, 8321 OLD COURTHOUSE ROAD, SUITE 200, VIENNA, VA, 22182-3817, US

(73) Assignee: NEC Corporation, Tokyo (JP)

(21) Appl. No.: 11/167,153

(22) Filed: Jun. 28, 2005

(30) Foreign Application Priority Data
Jun. 29, 2004 (JP) 2004-192042

(51) Int. Cl. H04M 3/42

(52) U.S. Cl. 455/416; 455/428

(57) ABSTRACT

A conference assisting system includes a plurality of conference room servers each disposed for one of conference rooms, and a network including a plurality of VLANs each disposed for one of departments to which participants belong. A user having a mobile terminal connected to a VLAN specifies another mobile terminal to share conference files with the another mobile terminal. The user uses the conference server to project a file in the own mobile terminal for presentation by using an image projector through the conference sever.

### BACKGROUND OF THE INVENTION

(a) Field of the Invention

The present invention relates to conference assisting system and method and, more particularly, to conference assisting system and method, which assist processings in a conference held by using a conference room server and a plurality of mobile terminals such as personal computers and personal data assistants.

(b) Description of the Related Art

Recently, a conference assisting system is used to hold a conference allowing participants to use own mobile terminals such as personal computers and personal data assistants. A conventional conference assisting system is described in Patent Publication JP-A-2003-140829. FIG. 24 shows the conference assisting system described in the publication in a block diagram.

The conference assisting system 1 includes a conference server 12 and an image projector 11 controlled by an image projector controller 25 in the conference server 12. A storage device 23 stores therein programs and files to be displayed on the image projector 11. An operating device 26 controls page-turns etc. of a file projected by the image projector 11. A CPU 21 in the conference server 12 operates based on execution programs stored in the storage device 23 while using a memory 22 as a work area. Remote clients 3 are implemented by personal equipment such as mobile terminals, personal computers, personal digital assistants and the like, which may be referred collectively to as mobile terminals hereinafter. A communication interface 24 operates for communication between the conference assisting system 1 and remote clients 3.

It is noted that the conventional conference assisting system as described above has a drawback in the difficulty of sharing files between the participants. Each participant may wish to obtain the conference materials in hand as needed while browsing the conference materials on the screen of the image projector. Thus, a file swapping function provided in the system swaps the conference files to efficiently proceed with the conference. If business customers participate in the conference, the number of participants varies depending on the conferences. In this case, information of the mobile terminals owned by the customers is not known beforehand among the participants.

In the situations as described above, the conference assisting system described in the publication has no scheme to share adhoc files among the participants, that may include business customers happened to participate in the conference. In this case, it is impossible to set the configurations of the personal computer beforehand that should share the conference files with other computers. This necessitates setting configurations of the personal computers in the conference room and consumes a relatively long time, providing a first problem to be solved by the present invention.

A second problem in the conference assisting system is that there is a difficulty in access of the equipment or output devices, such as image projector and printer, provided in the conference room. For example, in order for projecting a file installed in a notebook mobile terminal of a participant onto a screen of the image projector, the plug of a CRT cable must be inserted in a socket of the notebook mobile terminal. If a next presenter has a file to be projected, the CRT cable must be switched from the socket of the notebook mobile terminal to the socket of another mobile terminal or personal data assistant, which consumes a significant time length. Although a CRT switching device may be used for switching the CRT cable, all the participants or presenters must insert the CRT cables to the sockets of own computers, which also consumes a significant time length.

A third problem is that it is difficult for the participant to access at his discretion a file stored in his own office through a network. This necessitates the participant to return to his office and copy the file into a portable memory device such as a USB memory. On the other hand, if it is possible for the participants to access a radio network in the conference room, a customer participant should not be allowed to access a radio office network, because such an access to the radio office network involves a risk as to the security of the vendor company.

A fourth problem is that the conference assisting system does not provide a project assisting function, such as allowing an access to project materials of the past conference and adjustment of schedules of the persons other than the participants in the current conference. Such a project assisting function, if it is provided, should be accessed and used by the participants as well as the project members, and yet should not be accessed or used by another person other than the project members.

A fifth problem in the conference assisting system described in the publication is that a dedicated client software, referred to as a remote control client software, must be installed in the mobile terminals of the participants. This consumes a significant time length and involves a problem of a copy right or license fee of the software. In addition, a customer participant or external participant outside the company is not willing to install such a software due to a psychological resistance thereto because such a software may involve a problem of security of files in his own computer.

The install of the remote control client software as described above is to use a dedicated server software. More specifically, in order for the remote personal computer to control the cursor of the image projector, the dedicated server software is essential and necessitates communication thereto by using the client software. If the install itself of the client software is unnecessary, there is a possibility that a variety of configurations must be changed in the mobile terminal. This is because a plurality of conference server systems may be provided to respective conference rooms, and thus it must be determined in the mobile terminal of the participant which server in which conference room is now associated with the mobile terminal.

### SUMMARY OF THE INVENTION

In view of the above problems in the conventional conference assisting system, it is a first object of the present invention to provide a conference assisting system which is capable of allowing a plurality of mobile terminals received in a conference space or room to share conference files with one another.

It is a second object of the present invention to provide a conference assisting system which is capable of allowing a participant to use equipment in the conference room such as an image projector or a printer without changing configurations of his own mobile terminal.

It is a third object of the present invention to provide a conference assisting system which is capable of allowing a participant staying in a conference room to access his own office through his own mobile terminal and a network while prohibiting an unauthorized party from accessing the network, the unauthorized party including a party staying in another conference room using an access point shared with the participants in the subject conference.

It is a fourth object of the present invention to provide a conference assisting system which is capable of allowing a participant to access conference resources, such as previous materials of the project for which the conference is held and a schedule list tabulating schedules of other project members.

It is a fifth object of the present invention to provide such conference assisting systems as described above, which are capable of presenting the conference assisting functions without a need for the participant to install a dedicated client software in his own mobile terminal.

In one example, the present invention provides a conference assisting system including: a plurality of mobile terminals each related with a conference room and connected to a network; an AP router accepting a file sharing request from a user through one of the mobile terminals and the network, the file sharing request specifying a file or folder and another of mobile terminals storing therein the file or folder; a target DHCP server responding to a request from each of the mobile terminals to set an address of the each of the mobile terminals; and a session server storing the address of the each of the mobile terminals in the AP router, wherein: the AP router, upon receiving the file sharing request, identifies an address of the another of the mobile terminals, transfers the file sharing request to the another of the mobile terminals, and allows the one of the mobile terminals to download the file or folder transferred from the another of the mobile terminals.

In another example, the present invention provides a method for assisting a conference including: connecting a plurality mobile terminals to a network, each of the mobile terminals being related with a conference room; responding to a request from each of the mobile terminals to set an address of the each of the mobile terminals; storing the address of the each of the mobile terminals in a memory; accepting a file sharing request from a user through one of the mobile terminals, the file sharing request specifying a file or folder and another of mobile terminals storing therein the file or folder: transferring the file sharing request to the another of the mobile terminals; and allowing the one of the mobile terminals to download the file or folder transferred from the another of the mobile terminals.

In accordance with the one and another examples of the present invention, a file sharing function can be achieved among the mobile terminals without installing a dedicated client software in the mobile terminals.

In another example, the present invention provides a conference assisting system including: a plurality of mobile terminals each related with a conference room and connected to a network; a target DHCP server responding to a request from each of the mobile terminals to set an address of the each of the mobile terminals; an AP router accepting a file upload request from an originating mobile terminal among the mobile terminals; a session server storing the address of the each of the mobile terminals in the AP router; a conference room server disposed for the conference room; and an output device connected to the conference room server and used in the conference room, the file upload request specifying the output device and a file to be uploaded on the conference room server, wherein the AP router, upon receiving the file upload request, transfers the file upload request to the conference room server; and the conference room server receives the file from the originating mobile terminal to allow the output device to operate based on the received file.

In another example, the present invention also provides a method for assisting a conference including: connecting a plurality of mobile terminals to a network, each of the mobile terminals being related with a conference room; responding to a request from each of the mobile terminals to set an address of the each of the mobile terminals; storing the address of the each of the mobile terminals in a memory; accepting a file upload request from an originating mobile terminal among the mobile terminals, the file upload request specifying an output device and a file to be uploaded on a conference room server; receiving the file from the originating mobile terminal in the conference room server to allow the output device to operate based on the received file.

In accordance with the last two examples of the present invention, the output device can be operated by using each of the mobile terminals without installing a dedicated client software in the each of the mobile terminals.

The above and other objects, features and advantages of the present invention will be more apparent from the following description, referring to the accompanying drawings.

### BRIEF DESCRIPTION OF THE DRAWINGS

FIG. 1 is a block diagram of a conference assisting system according to a first embodiment of the present invention.

FIG. 2 is a flowchart of the processings of mobile terminals of participants in an IP address setting procedure in the conference assisted by the conference assisting system of FIG. 1.

FIG. 3 is a flowchart of the processings in a login procedure of the mobile terminals in the conference.

FIG. 4 is a flowchart of the processings after a successful certification in the login of the mobile terminals in the conference.

FIG. 5 is a flowchart of the processings in preparing information of portal screen in the conference.

FIG. 6 is a flowchart of the processings after an unsuccessful certification in the login of the mobile terminals in the conference.

FIG. 7 is an example of a screen image including icons specifying the participants in the conference.

FIG. 8 is a flowchart of the processings in an image projecting function in the conference.

FIG. 9 is an example of a screen image appearing after clicking a command button for the image projecting function in the conference.

FIG. 10 is an example of an operation screen for using an image projector in a remote control in the conference.

FIG. 11 is a flowchart of processings for closing the image projecting function in the conference.

FIG. 12 is a flowchart of processings in sharing local files.

FIG. 13 is a flowchart of processings in a project login function in the conference.

FIG. 14 is an example of a screen image presented after clicking a project login button.

FIG. 15 is a flowchart of processings in a logout from the project.

FIG. 16 is a block diagram of a conference assisting system according to a second embodiment of the present invention.

FIG. 17 is a block diagram of a conference assisting system according to a third embodiment of the present invention.

FIG. 18 is a block diagram of a conference assisting system according to a fourth embodiment of the present invention.

FIG. 19 is a block diagram of a conference assisting system according to a fifth embodiment of the present invention.

FIG. 20 is a block diagram of a conference assisting system according to a sixth embodiment of the present invention.

FIG. 21 is a block diagram of a conference assisting system according to a seventh embodiment of the present invention.

FIG. 22 shows exemplified configurations of the session server, login server and certification setting sever in the conference assisting system of the present invention.

FIG. 23 shows exemplified configurations of the AP router and conference room server in the conference assisting system of the present invention.

FIG. 24 is a block diagram of a conventional conference assisting system.

### PREFERRED EMBODIMENT OF THE INVENTION

Now, the present invention is more specifically described with reference to accompanying drawings, wherein similar constituent elements are designated by similar reference numerals.

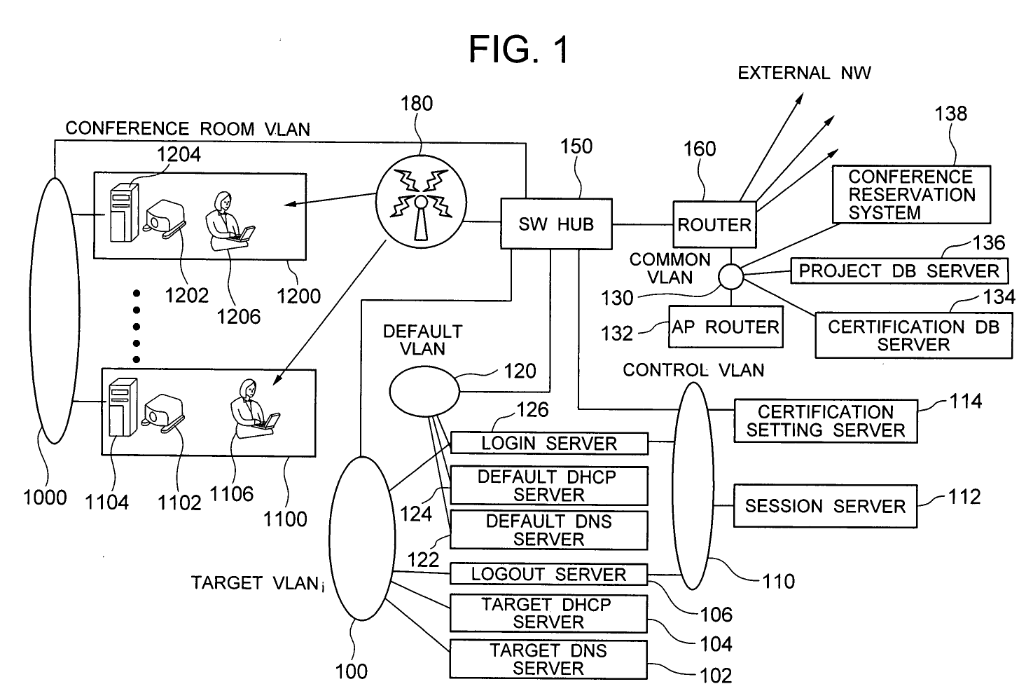

FIG. 1 shows a conference assisting system according to a first embodiment of the present invention. In FIG. 1, a login server 126 presents a login screen on each of mobile terminals carried by participants in a conference, and issues an inquiry of certification information to a certification setting server 114. The certification setting server 114 responds to the inquiry from the login server 126 to issue a corresponding inquiry to a certification database (DB) server 134. The certification setting server 114 returns a response as to the result of certification and a setting as to a virtual local area network (VLAN) based on the department to which the participant belongs, and enters in an application (AP) router 132 a correspondence between the user name, the IP address of the host or mobile terminal carried by the user and the conference room number.

Conference room servers 1204 and 1104 are provided in respective conference rooms 1200 and 1100, and connected to respective image projectors 1202 and 1102 installed in the respective conference rooms 1200 and 1100.

A SW (switching) hub 150 connects together, directly or indirectly, the certification setting server 114, a cession server 112, conference room servers 1204 and 1104, AP router 132, project DB server 136, and a conference room reservation server or conference room reservation system 138.

Mobile terminals 1106 and 1206, such as personal computers and personal data assistants, are carried by users staying in the respective conference rooms 1200 and 1100. An access point 180 is connected to these mobile terminals 1106 and 1206 through a wired network or a radio network. The image projectors 1202 and 1102 are provided in the conference rooms 1200 and 1100, respectively, and connected to the conference room severs 1204 and 1104, respectively. The conference rooms 1100 and 1200 receive therein the respective conference room servers 1104 and 1204, image projectors 1102 and 1202, mobile terminals 1106 and 1206 carried by the users. The conference room servers 1104 and 1204 are connected to a conference room VLAN 1000.

A default VLAN 120 is a VLAN first connected by the SW hub 150 to the mobile terminals 1206 and 1106 carried by the users before certification of the users. A default DHCP sever 124 delivers an IP address to each of the mobile terminals 1206 and 1106 connected to the default VLAN 120 before certification. A default DNS sever 122 responds to any host name of a mobile terminal, such as fully-qualified domain name (FQDN), delivered therefrom, to return the IP address of the login server 126 at any time irrespective of any inquiries delivered from the mobile terminal.

A logout server 106 responds to a request from a mobile terminal 1206 or 1106 after the certification thereof to deliver a logout screen, and responds to a logout request from a user to transfer the logout request to the session server 112. A target DHCP server 104 delivers an IP address to a mobile terminal after the certification thereof. A target DNS server 102 responds to a host name of a mobile terminal, such as FQDN, to return the IP address thereof so long as the mobile terminal is certified.

Each of a plurality of target VLANs (VLANi) 100 connect together the logout server 106, target DHCP server 104, target DNS server 102 and SW hub 150. The target VLAN 100 is provided for each of the departments to which the users belong.

The session server 112 receives a login request delivered from the login server 126, and issues an inquiry of certification to the certification setting server 114. If the certification is successful, the session server 112 instructs the SW hub 150 to switch the connection of the mobile terminal from the default VLAN 120 to the target VLAN 100. The session server 112 responds to a logout request delivered from the logout server 106, instructing the SW hub 150 to switch the connection of the certified user's mobile terminal from the target VLAN 100 to the default VLAN 120.

A control VLAN 110 connects together the certification setting server 114, login server 126, logout server 106, session server 112 and SW hub 150.

A router 160 is connected to the SW hub 150. The router 160 has a function of filtering a packet based on the sequential number (i) of the target VLANi 100, which is defined by a network address allocated to the target VLANi.

The conference reservation system 138 provides a user interface for reserving a conference room, and delivers a conference password for a reserved conference room. The certification DB server 134 stores therein a table specifying the correspondence between user IDs, passwords thereof, and departments to which the users belong, and the conference password delivered from the conference reservation system 138. The certification DB server 134 responds to an inquiry from the certification setting server 114, to return a pass or fail of the certification. The project DB server 136 stores therein project files prepared for achieving specific projects.

The AP router 132 stores therein a table specifying correspondences between mobile terminals and conference rooms, and a table specifying correspondences between conference room numbers and the IP addresses of the conference room servers. The AP router 132 transfers an access from a user through the mobile terminal toward a suitable destination.

A common LAN 130 connects together the router 160, AP router 132, certification DB server 134, project DB server 136 and conference reservation system 138.

In the conference assisting system of the present embodiment, the owner of the conference rooms has and manages the resources including the conference reservation system 138, project DB server 136, certification DB server 134, AP router 132, common LAN 130, router 160, SW hub 150, control VLAN 110, certification setting server 114, session server 112, default VLAN 120, login server 126, default DHCP server 124, default DNS server 122, logout server 106, target DHCP server 104 and target DNS server 102. The owner of the conference rooms also has and manages the conference room servers 1104 and 1204, and image projectors 1102 and 2202. The mobile terminals may be owned and controlled by the owner of the conference rooms. However, it is preferable that a mobile terminal be owned, carried, managed and controlled by the user or participant.

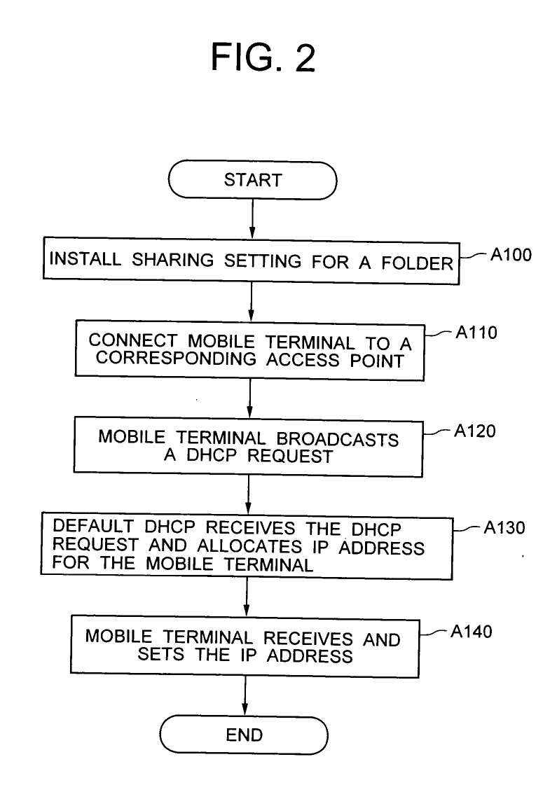

FIG. 2 shows a flowchart of preparatory processings including reception of a DHCP response by a mobile terminal 1206 and setting of an IP address for the mobile terminal 1206. In operation of the conference assisting system of FIG. 1, a mobile terminal 1206 carried by a user into the conference room 1200 is subjected to setting of sharing a specific folder. (step A100). For example, a notebook personal computer operating on Windows XP (trademark) system can be set to operate as a CIFS (common internet file system) server, which lays a folder stored in the personal computer open through the network.

Subsequently, the mobile terminal 1206 is connected to the access point 180 by an operation of the user (step A110). After this step, the mobile terminal 1206 can access via the access point 180 to the network including the SW hub 150 etc. The mobile terminal 1206 is first connected to the default LAN 120 via the function of the SW hub 150, such as VLAN switching function.

Thereafter, the mobile terminal 1206 broadcasts a DHCP (dynamic host configuration protocol) request through the default VLAN 120 (step A120). The default DHCP server 124 receives the DHCP request to allocate an IP address to the mobile terminal 1206 in the default DHCP server 124, and delivers a DHCP response including the IP address to the mobile terminal 1206 (step A130). The mobile terminal 1206 receives the DHCP response to set the IP address thereto (step A140).

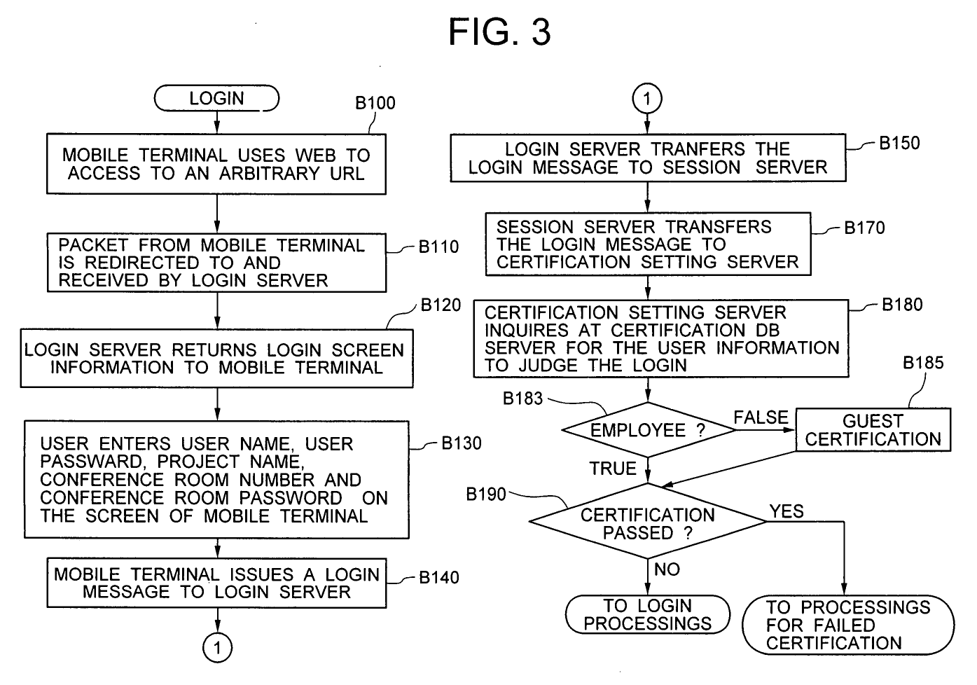

FIGS. 3 to 6 show flowcharts of logon processings of the mobile terminal 1206. The mobile terminal 1206 accesses to the network including the SW hub 150 etc. via the access point 180. The mobile terminal 1206 is first connected to the default VLAN 120 by the function of the SW hub 150, as described above. The user uses a Web browser on the mobile terminal 1206 to access a server via a casual or arbitrary URL (step B100). This access of the URL is forced to be redirected to an access of the login server 126 by the default DNS server 122, for example (step B110). The login server 126 responds to the access to return information of a login screen described in, for example, HTML to the mobile terminal 1206 (step B120). The user enters necessary data in the mobile terminal 1206, specifying five items including the user ID, user password, conference room number, conference room password, and department to which the user belongs, on the login screen (step B130). It should be noted that the data of the conference room number and the conference password may be omitted if, for example, the location of the user is identified by using a radio ID tag owned by the user. In addition, assuming that any user does not belong to a plurality of departments, the input of the department name of the user may be omitted because the department name is stored in the certification DB server 134 as will be detailed later.

The mobile terminal 1206 delivers login information entered on the login screen to the login server 126 (step B140). The login server 126 transfers the login information to the session server 112 via the control VLAN 110 by using, for example, a RADIUS protocol (step B150).

The session server 112 then transfers the login information to the certification setting server 114 (step B170). The certification setting server 114 issues a request of the information of the user, that delivered the login information, to the certification DB server 134. The certification DB server 134, in which the user ID, password and department of the user are stored in association, judges the certification to be successful if the user information stored therein conform to the login information (step B190).

If the participant is a client, the user data is not stored in the certification DB server 114. In this case, the certification setting server 114 performs a cross-check between the login information and the guest data including a guest ID and a guest password stored before the conference in the certification DB server 134 (step B185). If the guest ID is correct, the certification is deemed successful in step B190.

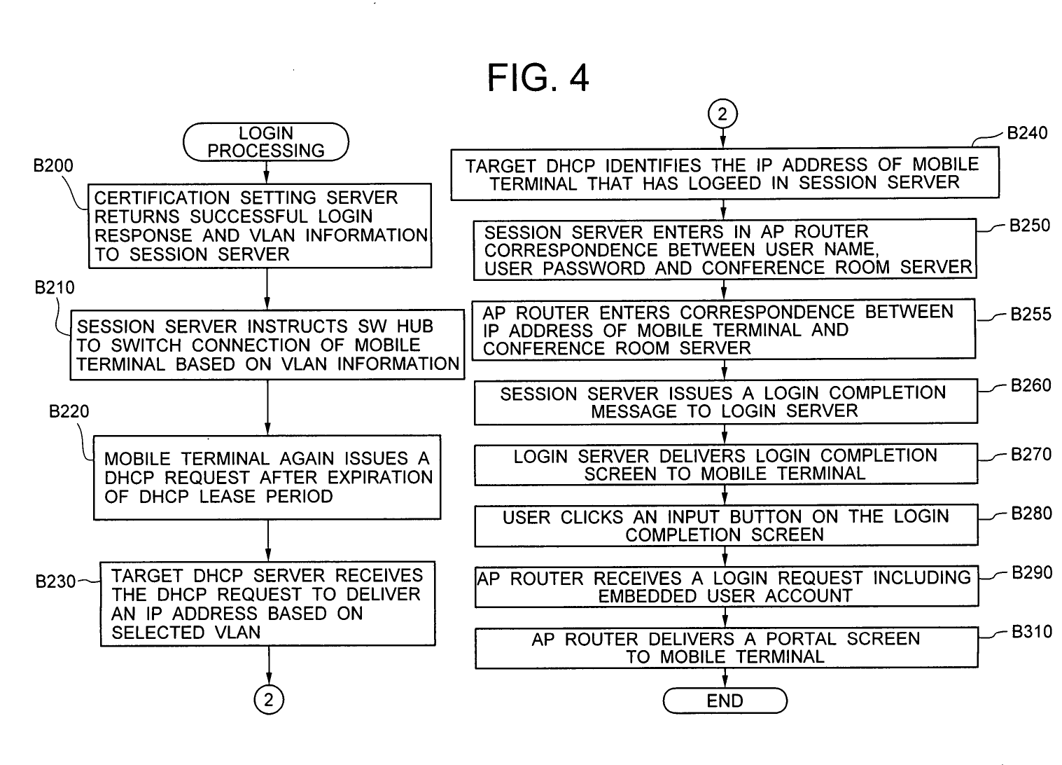

FIG. 4 shows processings after a successful certification. After the certification is deemed successful, the certification setting server 114 returns the VLAN_ID, or ID of the target VLANi 100 corresponding to the department of the user, to the session server 112 (step B200). The session server 112 issues an instruction to the SW hub 150 to switch the connection of the mobile terminal 1206 to a specific target VLAN corresponding to the VLAN_ID (step B210).

The mobile terminal 1206, after expiration of the lease period of the DHCP, again issues a DHCP request (step B220). If this DHCP request is delivered after switching to a suitable target VLAN, the DHCP request is received by the target DHCP server 104, whereby a suitable IP address can be set on the mobile terminal 1206 based on the current suitable target VLAN (step B230). That is, the target DHCP server 104 determines the IP address of the mobile terminal 1206. The determined information is delivered from the target DHCP server 104 to the session server 112 (step B240).

The session server 112 transmits the user ID and the IP address of the corresponding mobile terminal 1206 to the certification setting server 114 by using an accounting-start command in a RADIUS protocol (step B250). In this step, the session server 112 enters in the AP router 132 the correspondence between the user ID in combination with the conference room number both in the login information and the IP address of the mobile terminal determined by the target DHCP server 104. In addition, the certification setting server 114 enters in the AP router 132 the correspondence between the IP address of the mobile terminal 1206 and the IP address of the reference room server 1204 provided in the reference room 1200, based on the three relationships including the relationship between the user ID and the reference room number in the login information, the relationship between the reference room number and the IP address of the reference room 1200, and the relationship between the user ID and the IP address of the mobile terminal 1206 stored in the session server 112 (step B255).

The session server 112 returns a response informing completion of the certification (step B260). The login server 126 delivers information of a screen showing the login completion (step B270). The information of login completion to be displayed on the screen is described in HTML, for example. The mobile terminal 1206 displays on the screen thereof the login completion information thus received. The login screen includes information of the account and password of the user, which is embedded therein by means of a hidden tag described in Cookie or HTML. A confirmation button on the screen of the mobile terminal 1206 is depressed such as by clicking on the mouse by the user (step B280). Alternatively, the clicking of the confirmation button may be omitted here to proceed to the next step without any processing.

Mobile terminal 1206 issues a login request including the user account and user password embedded therein to the AP router 132 (step B290). The AP router 132 creates information of a portal screen and delivers the same to the mobile terminal 1206 (step B310).

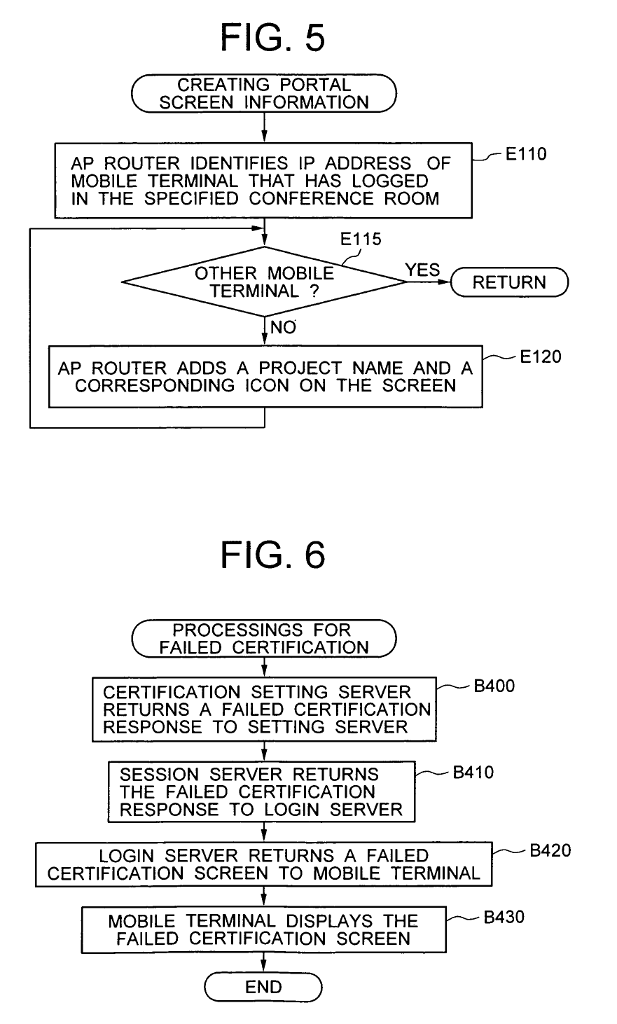

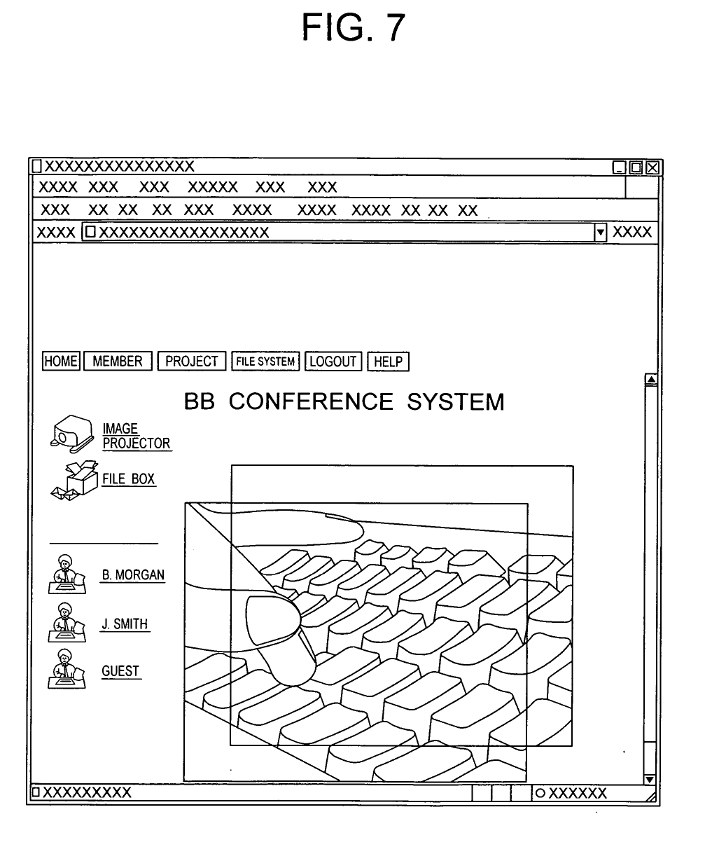

FIG. 5 shows processings for preparing information of the portal screen. The AP router 132 identifies the conference room number based on the IP address of the user's mobile terminal 1206, and identifies all the users that have logged in the same conference room. Then, the AP router 132 obtains all of the IP addresses of the mobile terminals staying in the conference room (step E110). The AP router 132 creates screen data such as described in HTML showing the correspondences between icons attached with the user's names and the IP addresses of the user's mobile terminals (step E120). FIG. 7 shows an example of the screen data thus created, wherein the screen data includes icons representing the participants on the left side of the screen. It is to be noted here that step E115 examines whether or not the processing of step E120 is finished for all of the users, and if it is not finished, the process returns to step E110 for identifying the IP address of another user.

FIG. 6 shows the processings to be conducted if the certification is failed in step B190. The certification setting server 114 returns a certification-failed response to the session server 112 (step B400), which returns the certification-failed response to the login server 126 (step B410). The login server 126 returns the screen data of the failed certification to the mobile terminal 1206 (step B420). The mobile terminal 1206 displays the failed certification on the screen. This allows the user to perceive entering of wrong data such as a wrong user ID or user password, a wrong department name, and a wrong conference room number or conference room password.

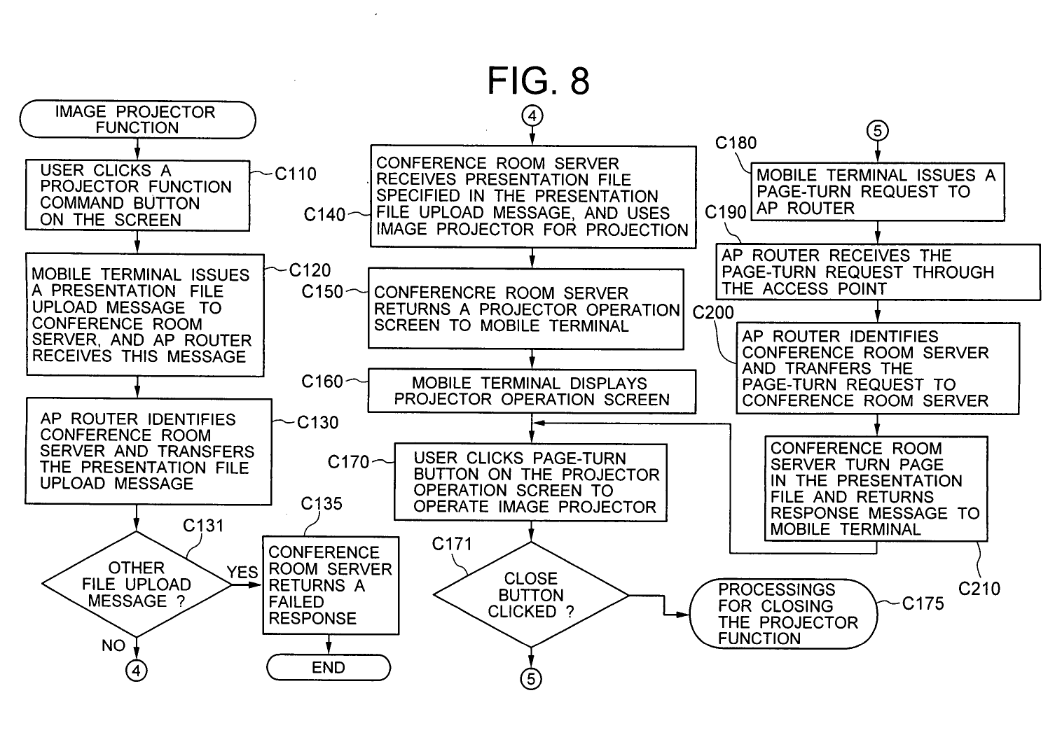

FIG. 8 shows detail of processings in the procedure of the image projector function in the present embodiment. The user clicks a command button of an image projector function on the screen of the mobile terminal 1206 (step C110). The screen image shown in FIG. 7 includes the icon for the image projector on the top of the icons on the left side, used as the image projector function command button.

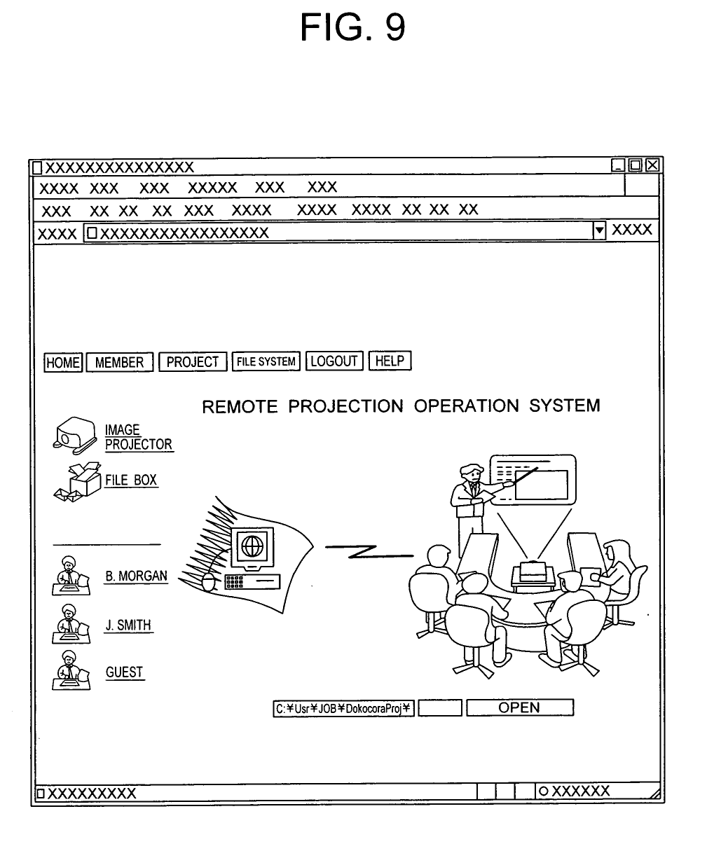

By clicking the image projector function command button, the mobile terminal 1206 displays thereon a screen image such as shown in FIG. 9. The screen image includes a dialogue box, wherein the user specifies the file name to be projected by the image projector. The mobile terminal 1206 issues a file upload message including destination of the message, i.e., conference room server 1204, request of using the image projector and the file name to be projected (step C120). The file upload message is delivered to the AP router 132 through the access point 180, SW hub 150 and router 160. The AP router 132 identifies the conference room based on the IP address of the originating mobile terminal 1206 with reference to the correspondence stored in step B250 between the IP address of the originating mobile terminal 1206 and the conference room. The AP router 132 transfers the file upload message to the conference room server 1204 (step C130).

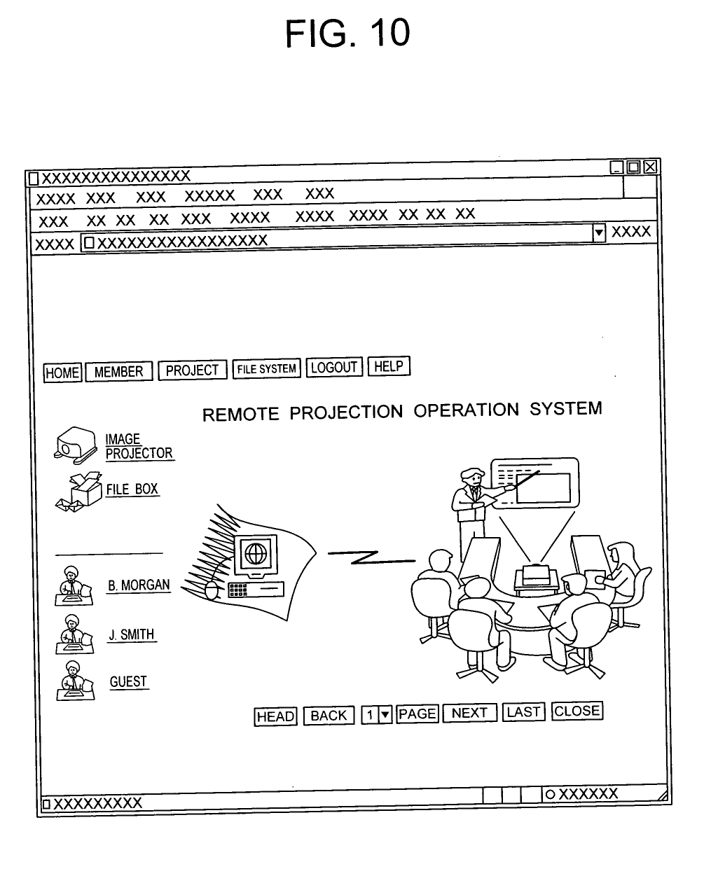

If it is judged in step C131 that another user has already uploaded a file, the conference room server 1204 returns information of an upload-failed response to the mobile terminal 1206 (step C135). The process is thus finished. On the other hand, if it is judged in step C131 that another file has not been uploaded, the conference room server 1204 receives the file specified by the file upload message, and controls the image projector 1202 to project the content of the file (step C140). The conference room server 1204 then returns a response message, which includes an operation screen for the image projector 1202, to the originating mobile terminal 1206 (C150). The mobile terminal 1206, after receiving the response message, displays an image projector operation screen such as shown in FIG. 10 (step C160). The user operates the image projector 1202 by clicking the buttons, such as for page-turn, displayed on the bottom side of the operation screen of the mobile terminal 1206 (step C170). If a closing button is clicked on the operation screen, closing processings are conducted as will be detailed later.

The procedure of a button click other than the closing-button click will be detailed hereinafter. Upon clicking of a page-turn button, for example, the mobile terminal 1206 issues a page-turn request message to the AP router 132 (step C180). The page-turn request message is delivered through the access point 180, SW hub 150 and router 160 to the AP router 132. The AP router 132 identifies the conference room 1200, in which the user stays, among the plurality of conference rooms based on the IP address of the originating mobile terminal 1206 with reference to the correspondence stored in step B250 between the IP address and the conference room. The AP router 132 transfers the page-turn message to the conference room server 1204 (step C200).

The conference room server 1204 turns the page of the file projected by the image projector 1202 and returns a response message to the originating mobile terminal 1206 (step C210). The steps C170 to C180 are iterated based on the requests from the user through the mobile terminal 1206.

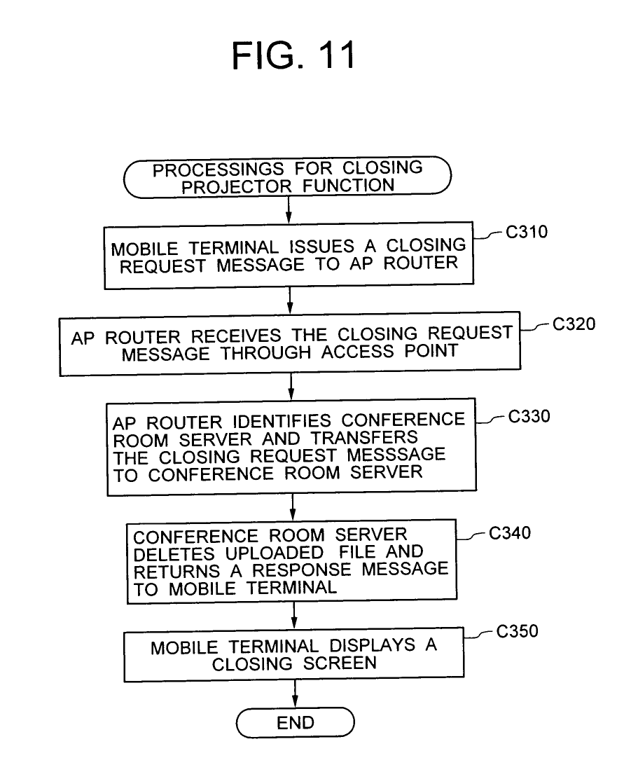

Processings in the case of clicking a closing button for the image projector 1202 will be described hereinafter. FIG. 11 shows the processings after the closing-button click for the image projector 1202. If the user clicks the closing button for the image projector 1202 on the operation screen of the mobile terminal 1206 in step C170, the mobile terminal 1206 issues a closing request message to the AP router 132 (step C310). The closing request message is delivered through the access point 180, SW hub 150 and router 160 to the AP router 132. The AP router 132, upon receiving the closing request message (C320), identifies the conference room 1200, in which the user stays among the plurality of conference rooms, based on the IP address of the originating mobile terminal with reference to the correspondence stored in step B250 between the IP address and the conference room. The AP router 132 then identifies the IP address of the conference room server 1204 among the plurality of conference room servers based on the correspondence stored beforehand between the IP address of the conference room server and the conference room. The AP router 132 transfers the closing request message to the conference room server 1204 thus identified (step C330). The conference room server 1204 deletes the received file therefrom and returns information of a closing screen for the image projector 1202 to the mobile terminal 1206 (step C340), which displays thereon the closing screen for the image projector (step C350).

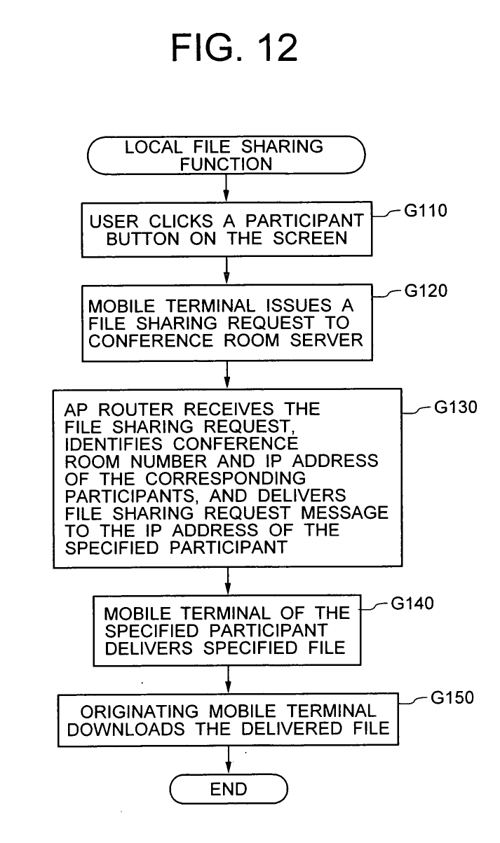

FIG. 12 shows a local file sharing function in the conference assisting system of the present embodiment. If a user clicks the icon of a participant displayed on the screen shown in FIG. 7 (step G110), the mobile terminal 1206 issues a file sharing request message to the AP router 132 (step G120). The AP router 132 identifies the conference room 1200, in which the user stays, among the plurality of conference rooms, based on the IP address of the originating mobile terminal 1206, with reference to the correspondence stored in step B250 between the IP address and the conference room. The AP router 132 then identifies the participants staying in the same conference room 1200 with reference to the correspondences between the participants that have logged in and the conference rooms. The AP router 132 then identifies the participant specified by the user and the IP address of the participant's personal computer. The AP router 132 issues a file access message such as in Samba to the participant thus identified (step G130). Samba is a software that allows a file sharing procedure among a plurality of personal computers.

The personal computer of the participant thus identified, upon receiving the file access message from the AP router 132, responds to the message to return the content of the file specified by the originating mobile terminal 1206 (step G140). The originating mobile terminal 1206 receives and downloads the content of the file and stores the same in the disk thereof (step G150).

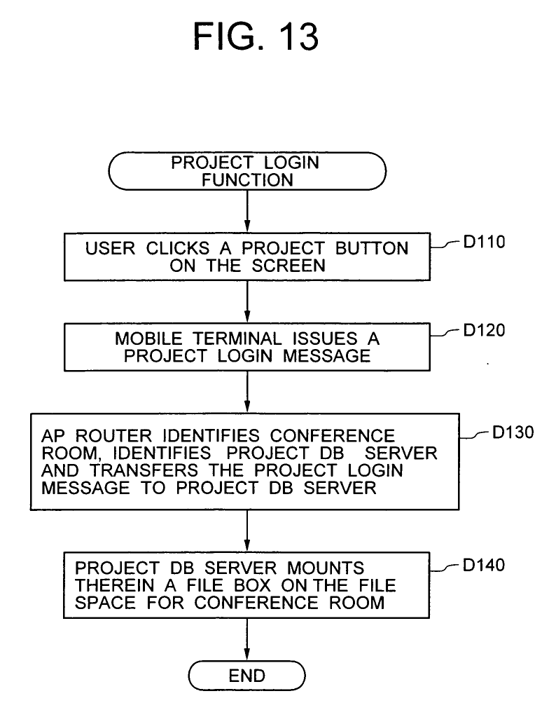

Next, a project login function in the present embodiment will be detailed hereinafter. FIG. 13 shows processings in the project login function. If a user clicks a project login button on the display screen of the mobile terminal 1206 (step D110), the mobile terminal 1206 issues a project login request message to the AP router 132 (step D120). In FIG. 9, the project login button is shown as a file box at the second icon from the top. In the present embodiment, the project DB server 136 has a file space for each of the conference rooms.

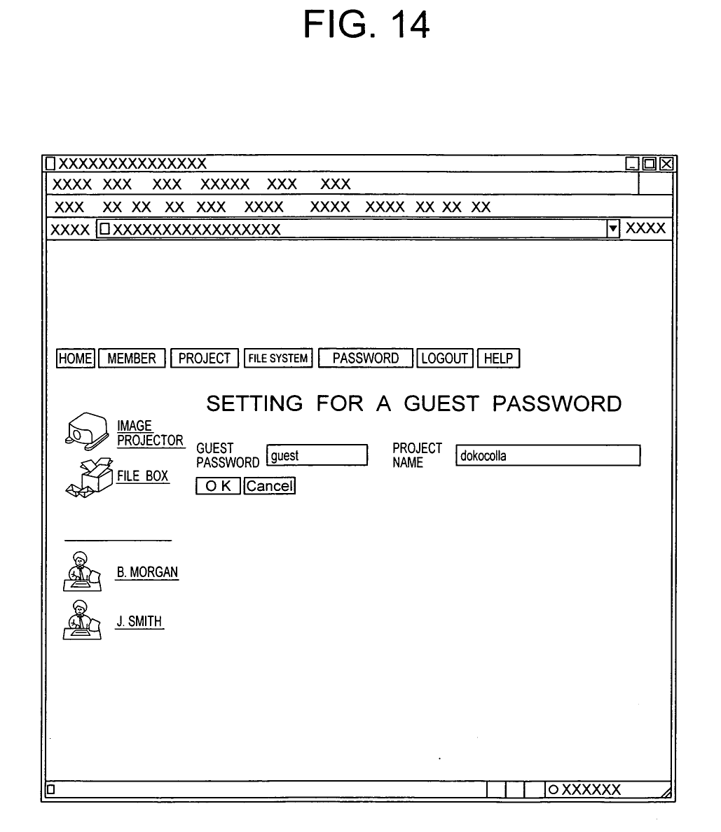

FIG. 14 shows the screen image of the mobile terminal upon clicking of the project login button, wherein the project name corresponding to the conference is entered in the dialogue box by the user. The AP router 132 identifies the conference room of the user based on the IP address of the originating mobile terminal 1206 with reference to the correspondences stored in step B250 between the IP address and the conference room.

The AP router 132 transfers a mount request message including the conference room number and the project name requested by the user to the project DB server 136, which is determined for the project beforehand (step D130). The project DB server 136 defines a project file box requested by the user for the project within the conference room file space, which has been provided for each of the conference rooms in the project DB server 136.

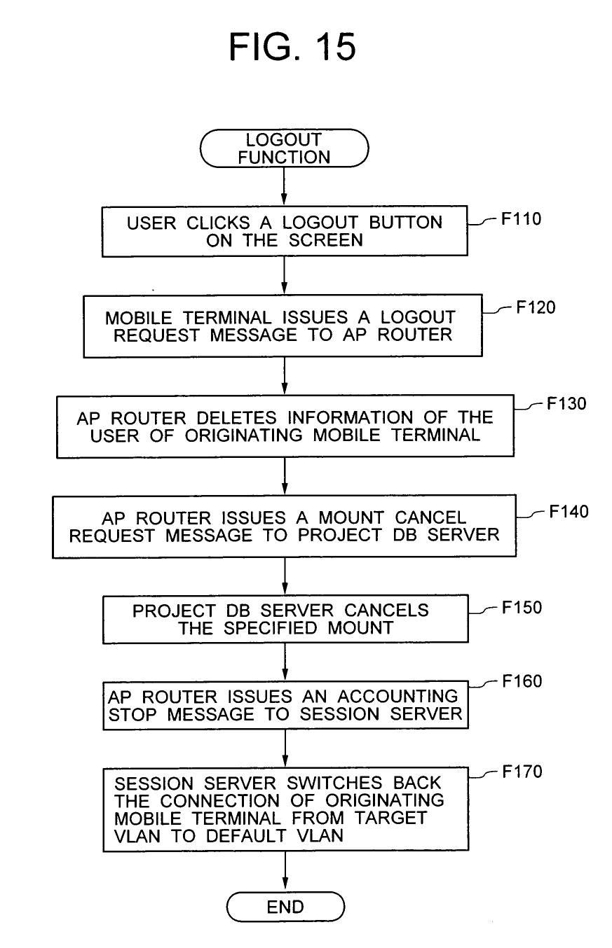

A project logout procedure in the present embodiment will be detailed hereinafter. FIG. 15 shows processings in the project logout procedure. If the user clicks a logout button on the project screen of the mobile terminal (step F110), the mobile terminal 1206 issues a project logout request message to the AP router 132 (step F12). The logout button is shown in the menu column of FIG. 7. The AP router 132 deletes the information of the user of the mobile terminal 1206 (step F130), and issues a mount cancel request message to the project DB server 136 (step F130), which cancels the mount by which the user logged in the project (step F150). The AP router 132 issues a message, such as Accounting Stop message in a RADIUS protocol, to the session server 112 (step F160). The session server 112 switches the connection of the user's mobile terminal 1206 from the state of being connected to the target VLAN 100 to the state of being connected to the default VLAN 120 (step F170). The SW hub 150 prohibit the mobile terminal 1206 from accessing to outside the default VLAN 120, whereby the mobile terminal 1206 cannot receive a variety of services other than the service through the default VLAN 120.

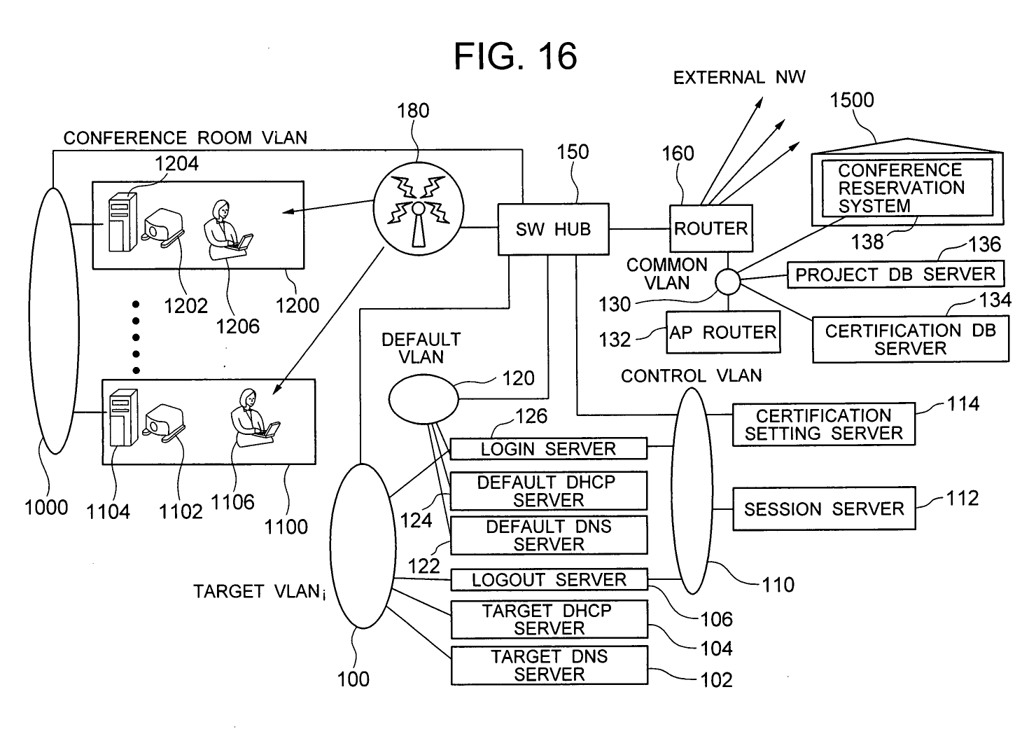

FIG. 16 is a block diagram of a conference assisting system according to a second embodiment of the present invention. In the case of the first embodiment, the owner of the conference rooms owns and manages all the systems and equipment, such as the conference reservation system 138. In the case of the second embodiment, the conference reservation system 138 is owned and managed by another enterprise (outsourcer) 1500 and used in this conference assisting system through outsourcing. The operation and configuration of the conference assisting system of the second embodiment are similar to those of the first embodiment except for the outsourcing.

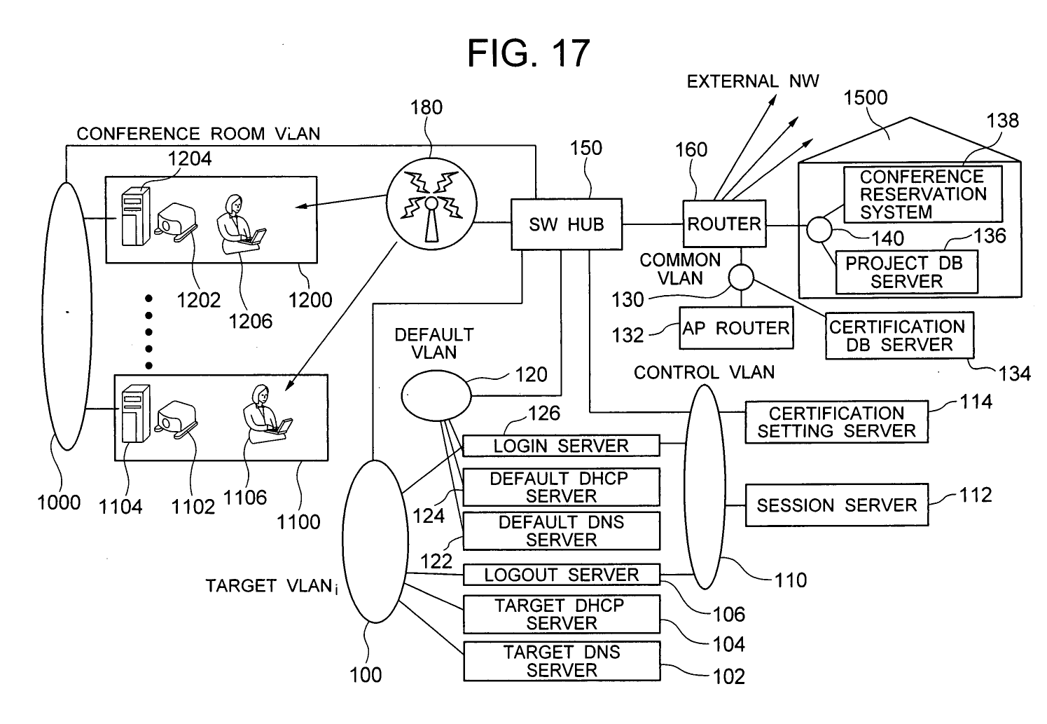

FIG. 17 is a block diagram of a conference assisting system according to a third embodiment of the present invention. In the present embodiment, the conference reservation system 138 and the project DB server 136 are owned and managed by another enterprise (outsourcer) 1500 and used in this conference assisting system through outsourcing. A hub 140 is provided to connect the equipment 138 and 136 thus outsourced to the router 160. The configuration and the operation of the system of the present embodiment are similar to those of the first and second embodiments except for the outsourcing.

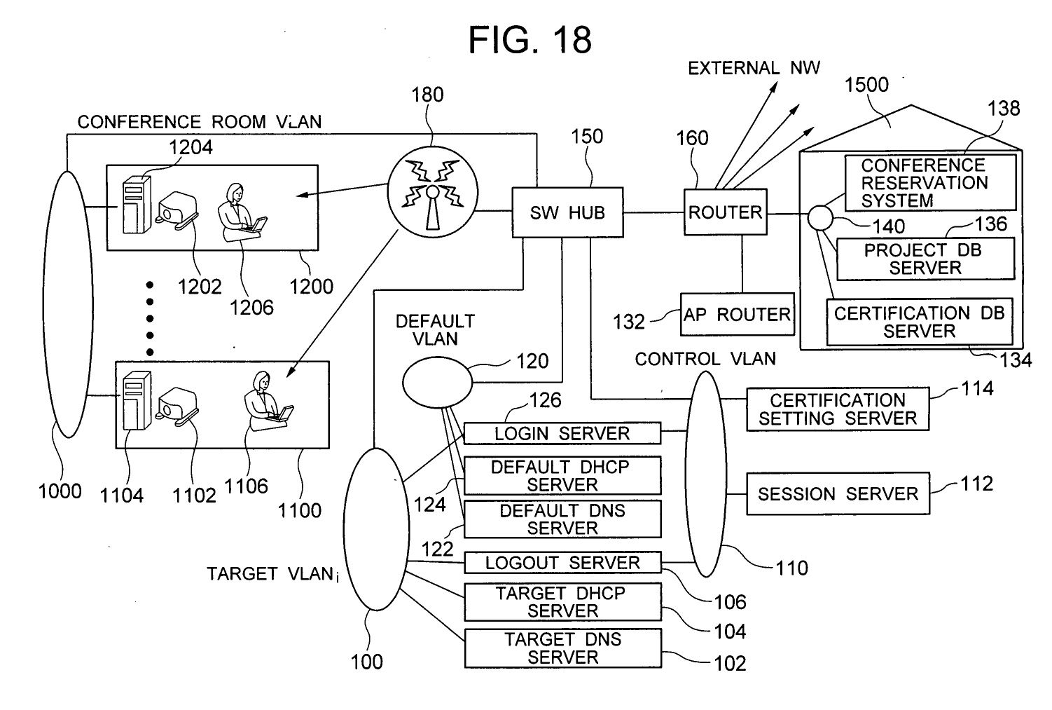

FIG. 18 is a block diagram of a conference assisting system according to a fourth embodiment of the present invention. In the present embodiment, the conference reservation system 138, project DB server 136 and certification DB server 134 are owned and managed by another enterprise (outsourcer) 1500 and used in this conference assisting system through outsourcing. A hub 140 is provided to connect equipment 138, 136 and 134 to the router 160. The configuration and operation of the system in the present embodiment are similar to those of the first through third embodiments except for the outsourcing.

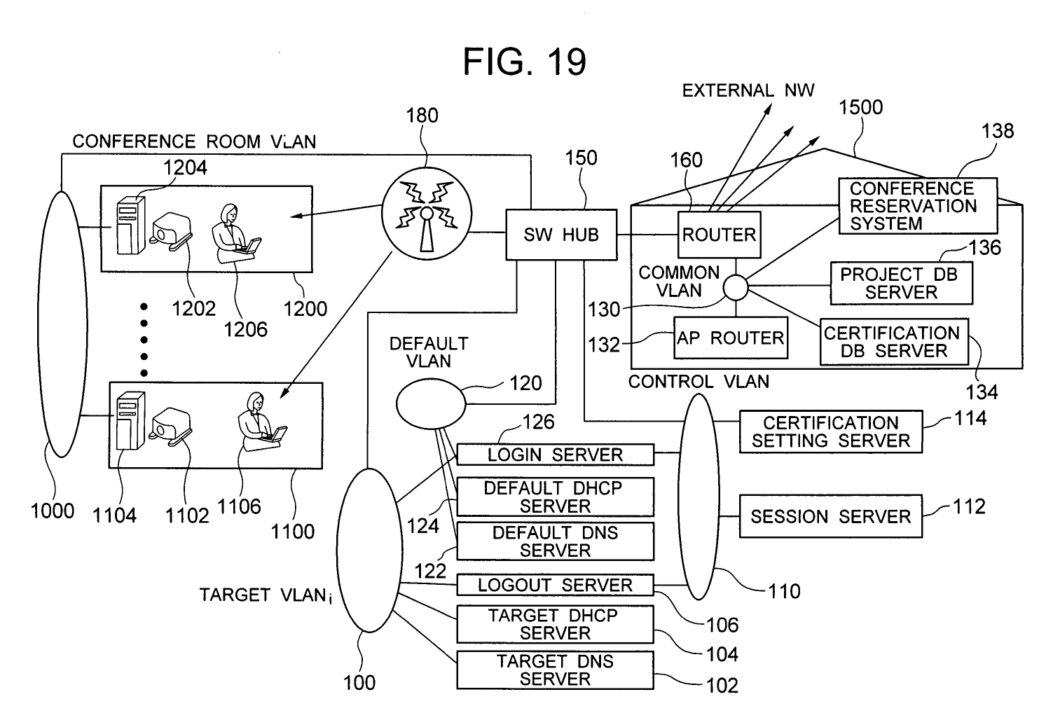

FIG. 19 is a block diagram of a conference assisting system according to a fifth embodiment of the present invention. In the present embodiment, the conference reservation system 138, project DB server 136, certification DB server 134, AP router 132, common LAN 130 and router 160 are owned and managed by another enterprise (outsourcer) 1500 and used in this conference assisting system through outsourcing. The configuration and operation of the system in the present embodiment are similar to those of the first through third embodiments except for the outsourcing.

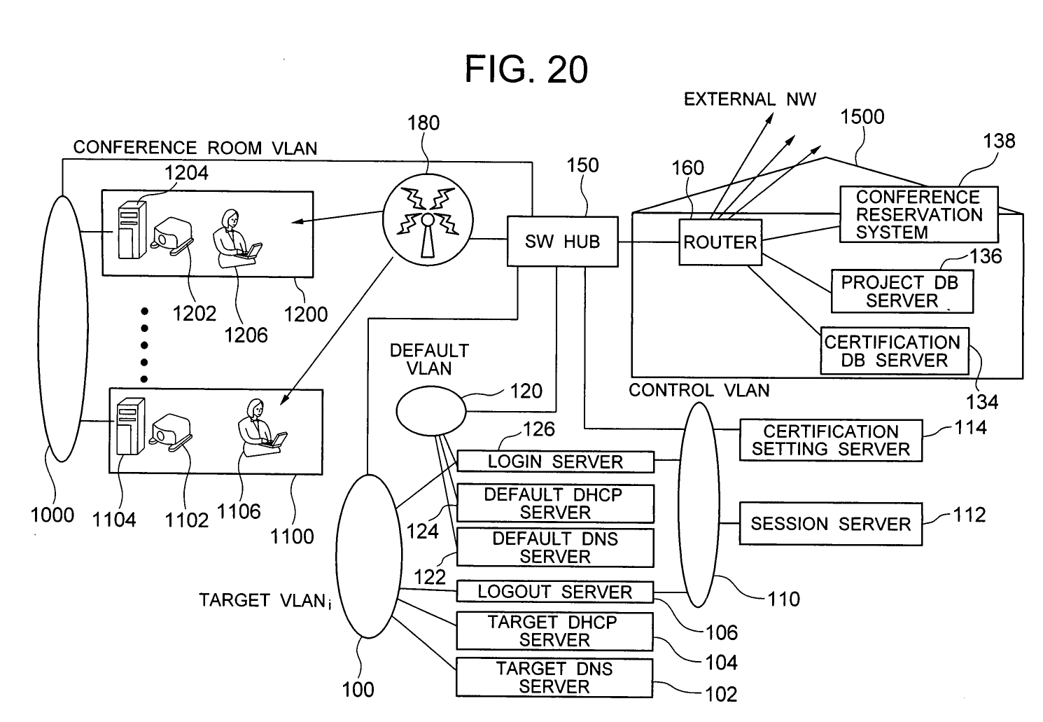

FIG. 20 is a block diagram of a conference assisting system according to a sixth embodiment of the present invention. In the present embodiment, the router 160, conference reservation system 138, project DB server 136 and certification DB server 134 are owned and managed by another enterprise (outsourcer) 1500 and used in this conference assisting system through outsourcing. In addition, the AP router 132 is connected to the SW hub 150, and the conference reservation system 138, project DB server 136 and certification DB server 134 are connected directly to the router 160. Although the network connections are thus different from the above-described embodiments, the operation of the system is similar to those of the above-described embodiments.

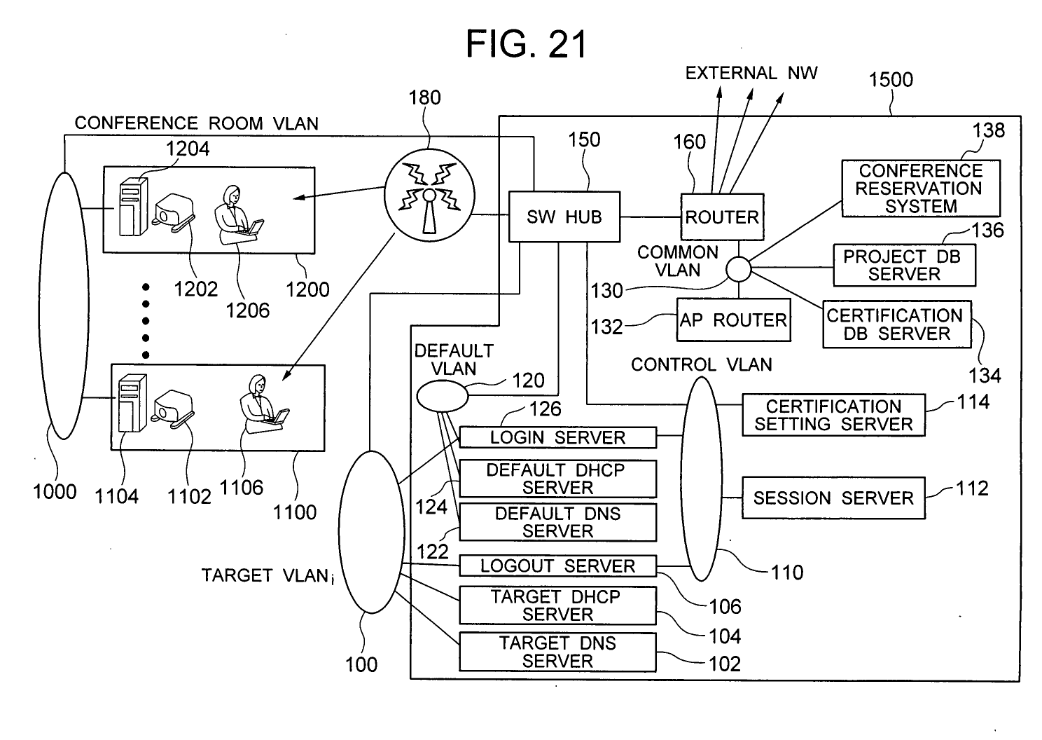

FIG. 21 is a block diagram of a conference assisting system according to a sixth embodiment of the present invention. In the present embodiment, the conference reservation system 138, project DB server 136, certification DB server 134, AP router 132, common LAN 130, router 160, SW hub 150, control VLAN 110, certification setting server 114, session server 112, default VLAN 120, login server 126, default DHCP server 124, default DNS server 122, logout server 106, target DHCP server 104 and target DNS server 102 are owned and managed by another enterprise (outsourcer) 1500 and used in this conference assisting system through outsourcing. The operation of the system is similar to those of the above-described embodiments.

In the description of the above embodiments, the mobile terminal carried into the conference room accesses the image projector. The way of accessing by the mobile terminal to the printer is similar to the access to the image projector.

A conference assisting system according to an embodiment of the present invention may include the certification setting server 114 and AP router 132. The certification setting server 114 enters in the AP router 132 the correspondence between the conference room number entered together with the certification information by the user and the IP address of the mobile terminal carried by the user that logged in after the certification based on the certification information. As a result, the AP router 132 obtains a table tabulating the IP addresses of all of the mobile terminals carried by the participants staying in a common conference room. In addition, by the function of a daemon, such as Samba, running on the server, the AP router 132 can identify the IP address of a participant upon accessing to the participant by another participant. The AP router 132 then issues a file-list request message or a file request message to the mobile terminal having the thus identified IP address. The mobile terminal responds to the request to deliver the file list or the file requested by the message, whereby a file sharing function is achieved among the plurality of mobile terminals, such as personal computers, carried by the participants. Thus, the first object of the present invention can be achieved.

A conference assisting system according to another embodiment of the present invention may include the certification setting server 114 and AP router 132. The certification setting server 114 enters in the AP router 132 the correspondence between the conference room number entered together with the certification information by the user and the IP address of the mobile terminal carried by the user that logged in after the certification based on the certification information. The AP router 132, upon accessing to the image projector or printer by a mobile terminal, judges a corresponding conference room server among the plurality of conference room servers, to which the image projector or printer request package should be transferred, with reference to the correspondences stored beforehand between the conference rooms and the conference room servers. Thus, the second object of the present invention is achieved, A conference assisting system according to another embodiment of the present invention may include the session server 112, SW hub 150 and router 160. The session server 112 receives from the certification setting server 114 the information including the result of the certification of the user and to which VLAN the user belongs. The session server 112 then controls the SW hub 150 based on the received information, to determine to which domain of the network the mobile terminal of the user that logged in should belong. This determines the part of the IP address to which the mobile terminal belongs. The router 160 examines the part of the IP address of the mobile terminal, and filters the packets accessing to the network outside the conference room based on the part of the IP address. Thus, an employee of the company is allowed to access the network inside the office of the company, whereas a participant other than the employee, such as a client, is denied to access the network inside the office of the company due to the filtering by the router 160. Thus, an unauthorized participant cannot access the network outside the conference room although the participant is allowed to access to his own office through an external network. Thus, the third object of the present invention can be achieved.

A conference assisting system according to another embodiment of the present invention may include the certification setting server 114 and project DB server 136. The project DB server 136 defines therein a mount point for each of the conference rooms. The certification setting server 114 determines so that the participants in the conference are allowed to access to the mount point for the corresponding conference room. The user is also authorized to access the files of the project that the user belongs to. The user may operate the mobile terminal to issue a mount request message to the project DB server 136, the mount request message requesting mount of own files in connection with the project to the mount point. Thus, the participants in the conference can access to the files mounted for the project during a mount period. This mount is cancelled after the conference is ended. Thus, the participants in the conference have continuous access means that allows the participants to access the mount point during the conference, and the fourth object of the present invention can be achieved.

A conference assisting system according to another embodiment of the present invention may include the AP router 132, login server 126, and conference room servers 1204 and 1104, each of which acts as a Web server. It is assumed here that only the Web browser and Samba are installed in the user's client terminals. These AP router 132, login server 126, and conference room servers 1204 and 1104 use screen languages, such as simple HTML, which can be interpreted by a Web browser. Thus, so long as the Web browser is installed in the client terminals, the conference assisting functions can be used by the client terminals. In addition, since the sharing of the files among the mobile terminals carried by the user is achieved by using Samba, the file sharing function can be achieved so long as Samba is installed in the mobile terminals. Thus, the fifth object of the present invention can be achieved without installing a dedicated, new software in the mobile terminals carried by the participants.

### EXAMPLE

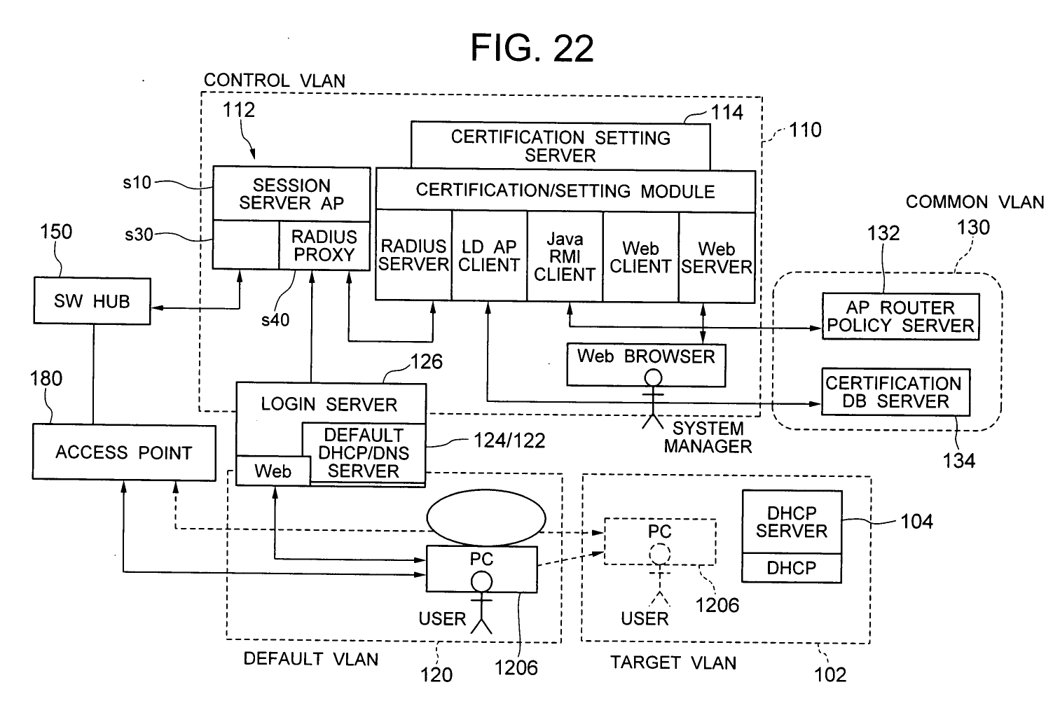

FIG. 22 shows an example of combination of the session server 112, login server 126 and certification setting server 114 in the conference assisting system of the embodiment. The login server 126 installs therein a Web browser which receives and responds to a HTTP request. The login server 126 may include therein the default DHCP server 124.

The session server 112 has a RADIUS proxy function s40, which transfers a login request delivered from the login server 126 toward the certification setting server 114. Based on the result of the response to the transferred packet, the session server AP 112 sets the layer-2 switch, i.e., SW hub 150 to switch the connection of the mobile terminal 1206 from the default VLAN 120 to a target VLAN 100i corresponding to the organization of the user.

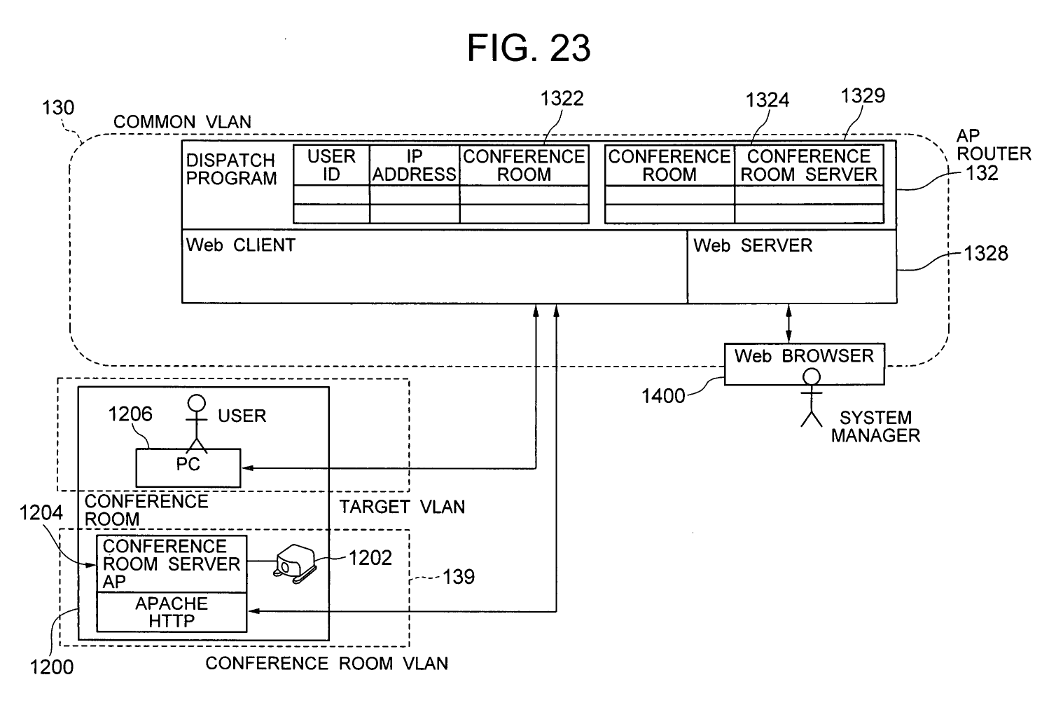

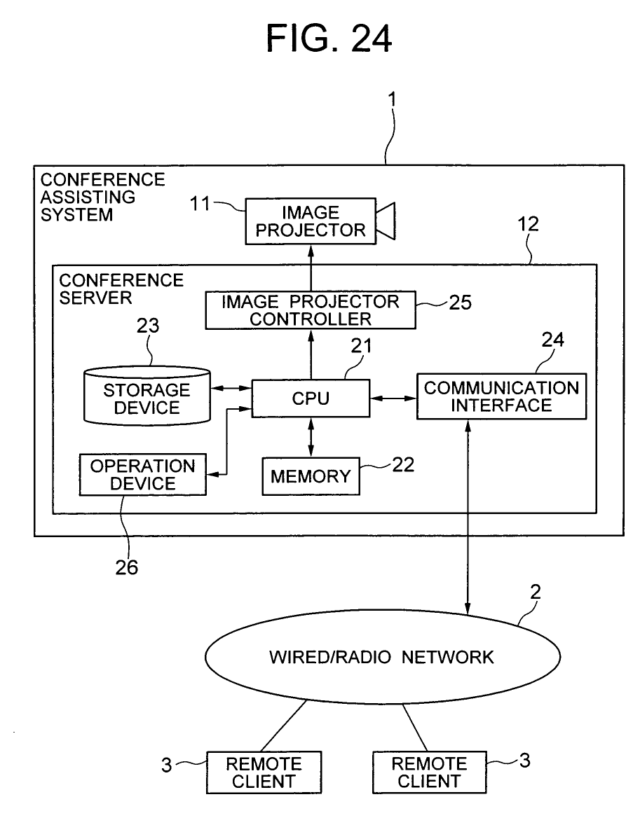

FIG. 23 shows an example of combination of the AP router 132 and conference room server 1204. The AP router 132 stores therein a table 1322 managing the correspondence between the user ID, the IP address of the notebook personal computer (mobile terminal) carried by the user, and the conference room in which the user stays, and a table 1324 managing the correspondence between the conference room number and the IP address of the conference room server provided in the conference room. The AP router 132 has a Web client function 1326 and a Web server function 1328 as a protocol stack.

The conference room server 1204 includes therein a Web server, and conference room server AP 1200 installed in the conference room server 1204 by using a servlet function. The conference room server AP 1200 uses the image projector 1202 to project conference materials as slide-show presentations.

Processings by the mobile terminal or notebook personal computer 1206 to set the IP address thereof upon receiving a DHCP response will be detailed hereinafter with reference to FIG. 2. The note-book personal computer 1206 uses Windows XP (trademark) as the operating system thereof, is carried by a participant into the conference room 1200, and is set to share files of a folder having a prescribed file name “/My Documents/public/” among the participants (step A1000).

Subsequently, the mobile terminal 1206 selects a radio access point 180 based on the setting by the user. A cryptography key (WEP key) corresponding to the set access point 180 is allocated to the mobile terminal 1206, which is then connected to the radio access point 180 defined in IEEE802.11b (step A110). Thus, the mobile terminal 1206 is authorized to access the network including the SW hub 150 etc. via the access point 180. In this access, the mobile terminal 1206 is first connected to the default VLAN 120 by the function of the SW hub 150, such as a VLAN switching function.

The mobile terminal 1206 broadcasts a DHCP request (step A120). The default DHCP server 124 receives the broadcast DHCP request, allocates an IP address, for example “168.192.0.8”, for the mobile terminal 1206, and responds to the DHCP request by notification of the IP address. The mobile terminal 1206, upon receiving the IP address, sets own IP address at “168.192.0.8” (step A140).

A login procedure will be detailed with reference to flowcharts of FIGS. 3 to 5. The mobile terminal 1206 can access the network including the SW hub, i.e., layer-2 switch 150 via the radio access point 180. In this access, the mobile terminal 1206 is first connected to the default VLAN 120, “168.192.0.0/24”, by the VLAN switching function of the SW hub 150. The mobile terminal 1206 uses the Web browser to access a server by specifying an arbitrary URL such as “html://hogehoge” (step B100). This access is subjected to a forced redirection toward the login server 126 by, for example, the default DNS server 122 (step B110). The login server 126, upon this access, returns information of a login screen described in, for example, HTML to the mobile terminal 1206 (step B120). The user enters own information on the login screen of the mobile terminal 1206 (step B130). The information to be entered here includes, for example, the user ID such as “John Smith”, the user password such as “x38GG43e”, the conference room number such as “301”, the conference room password such as “dsa%313”, and the department that the user belongs to, such as “personnel department”.

The mobile terminal 1206 delivers the login information thus entered on the login screen to the login server 1206 (step B140). The login server 126 transfers the login information through the VLAN 110 to the session server 112 by using, for example, a RADIUS protocol (step B150).

The session server 112 then transfers the login information to the certification setting server 114 (step 170), which issues an inquiry to the certification DB server 134 as to the information of the employee that has logged in (step B180). The certification DB server 134 manages correspondence between the user ID, user password and department of the user. The certification DB server stores therein the information in this example that the “John Smith” has a user password “x38GG43e”, and belongs to both “personnel department” and “planning department”. In this case, the participant is certified as an employee in step B183 whereby the certification in step B190 is successful because the login information conforms to the data stored in the certification DB server 134.

If the participant is a client outside the company in step B183, the process advances to step B185. In general, the certification DB server 134 stores therein no information of the client. In this case, the client having a specific guest ID, such as “guest”, is stored before the conference in connection with the guest password, such as “Td@@d”, in the certification DB server 134. Thus, the login information is examined in step B185 whether or not the login information conforms to the information stored in the certification DB server 134, whereby the certification is deemed successful in step B190.

If the certification is successful in step B190, the process advances to step B200, wherein the certification setting server 114 returns to the session server 112 the VLAN_ID, “5” in this case, corresponding to the “personnel department” that the user belongs to. The session server 112 then issues an instruction to the SW hub 150 to switch and connect the mobile terminal to VLAN5 corresponding to “5” of the VLAN_ID (step B210).

The mobile terminal 1206 again issues the DHCP request after expiration of the DHCP lease period, five seconds in this example (step B220). In this step, if the mobile terminal is already connected to a suitable VLAN, the DHCP request thus issued is transferred through the target VLAN 100 to the target DHCP server 104, whereby a suitable IP address, such as “168.192.1.3”, is allocated for the mobile terminal (step B230). The target DHCP server 104 notifies the IP address “168.192.1.3” to the session server 112 (step B240). The session server 112 transfers information of the user ID, “John Smith”, and the IP address, “168.192.1.3”, of the mobile terminal 1206 to the certification setting server 114 by using an accounting-start command of the RADIUS protocol (step B250).

The certification setting server 114 enters in the AP router 132 the correspondence between the IP address, “168.192.1.3”, of the mobile terminal 1206 and the IP address, “168.192.10.92”, of the conference room server 1204 installed in the conference room, with reference to the relationship between the user ID, “John Smith”, and the conference room number, “301”, specified in the login information, the relationship between the conference room number. “301”, and the IP address, “168.192.10.92” of the conference room server 1204, and the relationship between the user ID and the IP address, “168.192.1.3”, of the mobile terminal 126 (step B255).

The session server 112 returns a certification completion response to the login server 126 (step B260). The login server 126 delivers information of a login completion screen to the mobile terminal 1206 (step B270), which displays thereon a login completion screen described in HTML. In this login completion screen, the user account, “John Smith” and user password, “x38GG43e” are embedded in the form of hidden tags such as in Cookie or HTML. The user clicks the confirmation button on the screen of the mobile terminal 1206 (step B280). The mobile terminal then issues a login request including therein hidden user account and user password to the AP router 132 (step B290).

The AP router 132 creates information of the portal screen by the processings in the steps E110 to E120, and returns the response to the mobile terminal 1206.

In the processings for creating the portal screen, the AP router 132 obtains the conference room number, “301”, with reference to the IP address, 168.192.1.3” of the mobile terminal 1206 carried by the user. Subsequently, the AP router 132 finds all of the users that correspond to the conference room number, i.e., that have logged in the conference room. Then, the AP router 132 obtains all of the IP addresses of the mobile terminals carried by the users (step E110). The AP router 132 creates screen information described in HTML including icons attached with the user names and having correspondences to the IP addresses of the mobile terminals, such as shown in FIG. 7. The screen image shown in FIG. 7 includes icons each attached with the user ID of the participant, such as “John Smith” and “guest”.

Processings according to the image projector function will be detailed hereinafter with reference to FIG. 8. If the user clicks the image projector function button shown at the left of the screen image of FIG. 7 (step C110), the mobile terminal 1206 displays the screen image shown in FIG. 9. The user enters the file name, such as “presentation material.ppt”, on the dialogue box on the screen. The mobile terminal 1206 then issues a file upload message specifying the use of image projector function and the file name to the conference room server 1204. The file upload message is received by the AP router 132 through the access point 180, SW hub 150 and router 160 (step C120). The AP router 132 identifies the conference room, “301”, based on the IP address of the originating mobile terminal 1206, with reference to table 1322 entered in step B250 to specify the correspondence between the IP address, “168.192.1.3, and the conference room number, “301”. The AP router 132 also identifies the IP address, “168.162.10.92” of the conference room server 1204 based on the conference room number, “301”, with reference to table 1324 stored beforehand. The AP router 132 issues a file upload message to the conference room server 1204 (step C130).

The conference room server 1204 receives the file upload message, receives the file, “presentation material.ppt”, specified therein from the originating mobile terminal 1206, and delivers the received file to the image projector 1202 for projection (step C140). The conference room server 1204 returns information of an operation screen for the image projector to the mobile terminal 1206 (step C150). The mobile terminal 1206 receives the information of the operation screen as the response from the conference room server 1204, to display thereon the operation screen (C160). The user operates the image projector by clicking buttons such as a page-turn button on the operation screen (step C170).

If the user clicks the page-turn button, for example, on the operation screen, the mobile terminal 1206 issues a page-turn request message to the AP router 132 (step C180). The page-turn request message is delivered to the AP router 132 via the radio access point 180, SW hub 150 and router 160. The AP router 132, upon receiving the page-turn request message (step C190), identifies the conference room, “301”, in which the user participates, among the plurality of conference rooms based on the IP address, “168.192.1.3”, of the originating mobile terminal 1206, with reference to the correspondence entered in step B250 between the IP address and the conference room. In addition, the AP router 132 identifies the IP address, “168.192.10.92”, of the conference room server 1204 among the plurality of conference room servers with reference to the correspondence in table 1324 stored beforehand. The AP router 132 transfers the page-turn message to the conference room server 1204, thereby instructing “advance” to the next page within the file (step C200).

The conference room server 1204 delivers the next page of the file to the image projector 1202, and issues a response to the mobile terminal (step C210). The mobile terminal 1206, AP router 132 and conference room server 1204 iterate the above procedure based on the click of the buttons on the operation screen.

Processings in the closing procedure for the projector function will be detailed hereinafter with reference to FIG. 11. If the user, “John Smith”, clicks the “close” button on the operation screen shown in FIG. 10 for closing the presentation, the mobile terminal 1206 issues a closing request message to the AP router 132 (step C310). The closing request message is delivered to the AP router 132 through the access point 180, SW hub 150 and router 160. The AP router 132, upon receiving the closing request message (step C320), identifies the conference room, “310”, in which the user stays, among the plurality of conference rooms, with reference to table 1322 entered in step B250. The AP router 132 also identifies the IP address, “168.192.10.92”, of the conference room server 1204 among the plurality of conference room servers, with reference to table 1324 stored beforehand to specify the correspondence between the IP address of the conference room server and the conference room. The AP router 132 then transfers the closing request message to the conference room server 1204 (step C330). The conference room server 1204 deletes the file uploaded thereon, and issues information of a closing operation screen (step C340), which the mobile terminal displays thereon (step C350).

Processings in the local file sharing function will be detailed with reference to FIG. 12. If the user, “John Smith”, clicks “guest” button specifying a participant on the screen of FIG. 7 (step G110), the mobile terminal 1206 issues a file sharing request message to the AP router 132 (step G120). The AP router 132 identifies the conference room, in which the user stays, among the plurality of conference rooms based on the IP address, “168.192.1.3”, of the originating mobile terminal 1206, with reference to table 1322. The AP router 132 also identifies participants including the users and the guests with reference to table 1322, and identifies the IP address of the guest specified by the file sharing request with reference to table 1322. The AP router 132 then issues a file access request message such as in Samba to the IP address of the mobile terminal carried by the guest thus specified (step G130).

The mobile terminal responds to the received file access request message to return the content of the file specified by the file access request message (step G140). The originating mobile terminal 1206 that issued the file sharing request message downloads the delivered file and stores the same in the disk thereof (step G150).

Processings in the project login function will be detailed hereinafter with reference to FIG. 13. If the user, “John Smith”, clicks the file-box icon on the screen of FIG. 9 (step D110), the mobile terminal 1206 displays thereon the screen image of FIG. 14. The user enters a project name, such as “Manhattan” corresponding to the conference, in the dialogue box. The mobile terminal 1206 issues a project login message to the AP router 132 (step D120). The AP router 132 identifies the conference room, “301”, based on the IP address, “168.192.1.3”, of the originating mobile terminal 1206 with reference to table 1322. The AP router then transfers a mount request message, that includes information of the conference room number, “301”, and the project name specified by the user, to the project DB server 136 which is specified beforehand (step D130). The project DB server 136 mounts a file box for the project “Manhattan” requested by the user on the file space reserved for the conference room, “301”, (step D140).

Processings in the logout procedure will be detailed hereinafter with reference to FIG. 15. If the user, “John Smith”, clicks a logout button on the screen shown in FIG. 7 (step F110), the mobile terminal 1206 issues a logout request message to the AP router 132 (step F120). The AP router 132 identifies the user based on the IP address of the mobile terminal 1206, and deletes the information of the user (step F130). The AP router 132 issues a mount cancel request message to the project DB server 136 (step F140). The project DB sever 136 cancels the mount of the project that the user logged in (step F150). The AP router 132 issues an “accounting stop” message in a RADIUS protocol (step F160). The session server 112 returns the connection of the mobile terminal from the state of being connected to the target VLAN 100 to the state of being connected to the default VLAN 120 (step F170). The SW hub 150 prohibits the mobile terminal from accessing to the outside of the default VLAN 120, whereby the mobile terminal can receive only the limited service from the conference assisting system.

Since the above embodiments are described only for examples, the present invention is not limited to the above embodiments and various modifications or alterations can be easily made therefrom by those skilled in the art without departing from the scope of the present invention.

1. A conference assisting system comprising:
a plurality of mobile terminals each related with a conference room and connected to a network;
an AP router accepting a file sharing request from a user through one of said mobile terminals and said network, said file sharing request specifying a file or folder and another of mobile terminals storing therein said file or folder;
a target DHCP server responding to a request from each of said mobile terminals to set an address of said each of said mobile terminals; and
a session server storing said address of said each of said mobile terminals in said AP router, wherein:
said AP router, upon receiving said file sharing request, identifies an address of said another of said mobile terminals, transfers said file sharing request to said another of said mobile terminals, and allows said one of said mobile terminals to download said file or folder transferred from said another of said mobile terminals.

2. The conference assisting system according to claim 1, further comprising a conference room server, and an output device connected to said conference room server and used in said conference room, wherein:
said AP router accepts a file upload request from an originating mobile terminal among said mobile terminals, said file upload request specifying said output device and a file to be uploaded on said conference room server;
said AP router, upon receiving said file upload request, transfers said file upload request to said conference room server; and
said conference room server receives said file or folder from said originating mobile terminal to allow said output device to operate based on said received file or folder.

3. The conference assisting system according to claim 1, further comprising a router for filtering packets, wherein:
said session server connects each of said mobile terminals to a selected one of VLANs in said network, selected based on information of a department to which a user of said each of said mobile terminals belongs: and
said router filters packets depending on VLANs to which said mobile terminals are connected.

4. The conference assisting system according to claim 1, wherein said AP router stores therein correspondences between a plurality of conference rooms and a plurality of conference room servers, and said session server also stores in said AP router a correspondence between said set address of said each of said mobile terminals and said conference room.

5. The conference assisting system according to claim 4, further comprising a project DB server mounting thereon a file space for each of projects corresponding to respective conference rooms, wherein:
said AP router accepts a file mount request and a file mount cancel request specifying one of said projects from each of said mobile terminals, transfers said file mount request and file mount cancel request to said project DB server.

6. The conference assisting system according to claim 1, wherein each of said mobile terminals installs therein a software having a file sharing function.

7. A conference assisting system comprising:
a plurality of mobile terminals each related with a conference room and connected to a network;
a target DHCP server responding to a request from each of said mobile terminals to set an address of said each of said mobile terminals;
an AP router accepting a file upload request from an originating mobile terminal among said mobile terminals;
a session server storing said address of said each of said mobile terminals in said AP router;
a conference room server disposed for said conference room; and
an output device connected to said conference room server and used in said conference room, said file upload request specifying said output device and a file to be uploaded on said conference room server, wherein:
said AP router, upon receiving said file upload request, transfers said file upload request to said conference room server; and
said conference room server receives said file from said originating mobile terminal to allow said output device to operate based on said received file.

8. A method for assisting a conference, comprising:
connecting a plurality mobile terminals to a network, each of said mobile terminals being related with a conference room;
responding to a request from each of said mobile terminals to set an address of said each of said mobile terminals;
storing said address of said each of said mobile terminals in a memory;
accepting a file sharing request from a user through one of said mobile terminals, said file sharing request specifying a file or folder and another of mobile terminals storing therein said file or folder;
transferring said file sharing request to said another of said mobile terminals; and
allowing said one of said mobile terminals to download said file or folder transferred from said another of said mobile terminals.

9. The method according to claim 8 further comprising:
accepting a file upload request from an originating mobile terminal among said mobile terminals, said file upload request specifying an output device and a file to be uploaded in a conference room server;
transferring said file upload request to said conference room server; and
receiving said file or folder from said originating mobile terminal to allow said output device to operate based on said received files or folder.

10. The method according to claim 8, wherein:
said connecting step connects each of said mobile terminals to a selected one of VLANs in said network selected based on information of a department to which a user of said each of said mobile terminals belongs; and
packets delivered from said mobile terminals are filtered depending on VLANs to which said mobile terminals are connected.

11. The method according to claim 8, further comprising storing correspondences between a plurality of conference rooms and respective conference room servers, wherein the step of said storing address stores a correspondence between said set address of said each of said mobile terminals and said conference room.

12. The method according to claim 11, further comprising:
mounting on a project DB server a file space for each of projects corresponding to respective conference rooms;
accepting a file mount request and a file mount cancel request specifying one of said projects from each of said mobile terminals; and
transferring said file mount request and file mount cancel request to said project DB server.

13. The method according to claim 8, wherein each of said mobile terminals installs therein software having a file sharing function.

14. A method for assisting a conference, comprising:
connecting a plurality of mobile terminals to a network, each of said mobile terminals being related with a conference room;
responding to a request from each of said mobile terminals to set an address of said each of said mobile terminals;
storing said address of said each of said mobile terminals in a memory;
accepting a file upload request from an originating mobile terminal among said mobile terminals, said file upload request specifying an output device and a file to be uploaded on a conference room server;
receiving said file from said originating mobile terminal in said conference room server to allow said output device to operate based on said received file.
